(19) United States
(12) Patent Application Publication
(10) Pub. No.: US 2026/0166892 A1
(43) Pub. Date: Jun. 18, 2026

(54) LIQUID DISCHARGE APPARATUS AND LIQUID DISCHARGE METHOD

(71) Applicants: Teppei KIKUCHI, Kanagawa (JP); Hiroyuki YAMASHITA, Kanagawa (JP); Er Sin KHOO, Kanagawa (JP)

(72) Inventors: Teppei KIKUCHI, Kanagawa (JP); Hiroyuki YAMASHITA, Kanagawa (JP); Er Sin KHOO, Kanagawa (JP)

(21) Appl. No.: 19/383,789

(22) Filed: Nov. 10, 2025

(30) Foreign Application Priority Data
Dec. 18, 2024 (JP) 2024-221462

(51) Int. Cl. B41J 11/00; B41J 29/377; B41M 7/00

(52) U.S. Cl. CPC B41J 11/00216; B41J 11/0022; B41J 11/0024; B41J 29/377; B41M 7/009

(57) ABSTRACT

A liquid discharge apparatus includes a liquid discharger, a conveyor, a downstream heater, an upstream heater, and a cooler. The liquid discharger discharges a liquid, onto a first face of a medium, in a discharge direction and is movable or arranged in a scanning direction orthogonal to the discharge direction. The conveyor faces a second face opposite to the first face and conveys the medium to the liquid discharger in a conveyance direction orthogonal to the scanning direction. The downstream heater is downstream from the liquid discharger in the conveyance direction and heats the first face of the medium. The upstream heater is upstream from the downstream heater and separated from the downstream heater in the conveyance direction, to heat the second face of the medium. The cooler cools at least a portion of the second face of the medium disposed between the downstream heater and the cooler.

### CROSS-REFERENCE TO RELATED APPLICATION

This patent application is based on and claims priority pursuant to 35 U.S.C. § 119(a) to Japanese Patent Application No. 2024-221462, filed on Dec. 18, 2024, in the Japan Patent Office, the entire disclosure of which is hereby incorporated by reference herein.

### BACKGROUND

### Technical Field

The present disclosure relates to a liquid discharge apparatus and a liquid discharge method.

### Related Art

In the related art, a liquid discharge apparatus discharges ink as a liquid to form an image on a recording medium. The liquid discharge apparatus includes a heater and a cooler. After the liquid discharge apparatus discharges, for example, ink onto a recording medium, the heater heats the ink on the recording medium to dry the ink. Then, the cooler cools the recording medium after the heating.

### SUMMARY

The present disclosure described herein provides an improved liquid discharge apparatus including a liquid discharger, a conveyor, a downstream heater, an upstream heater, and a cooler. The liquid discharger discharges a liquid, onto a first face of a medium, in a discharge direction and is movable or arranged in a scanning direction orthogonal to the discharge direction. The conveyor faces a second face of the medium opposite to the first face and conveys the medium to the liquid discharger in a conveyance direction orthogonal to the scanning direction. The downstream heater is disposed downstream from the liquid discharger in the conveyance direction. The downstream heater heats the first face of the medium. The upstream heater is disposed upstream from the downstream heater and separated from the downstream heater in the conveyance direction, to heat the second face of the medium. The cooler cools at least a portion of the second face of the medium disposed between the downstream heater and the cooler.

Further, the present disclosure described herein provides an improved liquid discharge method including discharging a liquid, onto a first face of a medium, in a discharge direction at a liquid discharge position, conveying the medium to the liquid discharge position in a conveyance direction orthogonal to the discharge direction, heating the first face of the medium at a downstream position downstream from the liquid discharge position in the conveyance direction, heating a second face of the medium opposite the first face at an upstream position upstream from the downstream position in the conveyance direction, and cooling at least a portion of the second face of the medium at the downstream position in the conveyance direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of a liquid discharge apparatus;

FIG. 2 is a cross-sectional view of a liquid discharge apparatus; and

FIG. 3 is a schematic view of heaters in a liquid discharge apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of the present disclosure are described below with reference to the drawings. In the drawings, like reference signs denote like elements, and overlapping descriptions may be simplified or omitted as appropriate. In the following description, a description is given of a liquid discharge apparatus that discharges ink as a liquid.

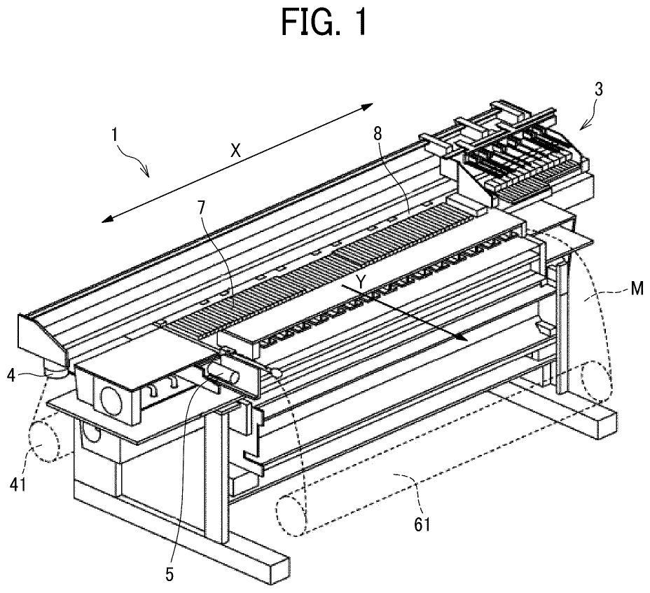

FIG. 1 illustrates a configuration of a liquid discharge apparatus 1 as an image forming apparatus. As illustrated in FIG. 1, the liquid discharge apparatus 1 includes a carriage 3, a main-scanning motor 4, a sub-scanning motor 5, a support 7, and a guide rod 8.

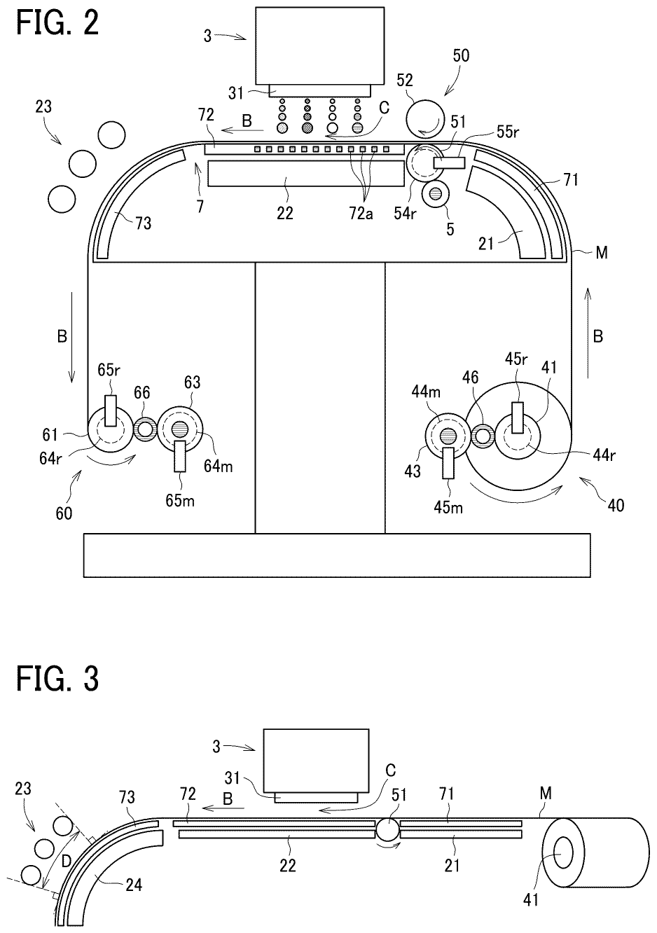

The carriage 3 includes multiple inkjet liquid discharge heads 31 (refer to FIG. 2). Each of the liquid discharge heads 31 serves as a liquid discharger. Each of the liquid discharge heads 31 discharges a predetermined color ink. The liquid discharge heads 31 are mounted on the carriage 3 such that the discharge faces thereof face downward. The carriage 3 is supported by the guide rod 8 extending in a main scanning direction X. Due to the driving of the main-scanning motor 4, the carriage 3 including the liquid discharge heads 31 is movable and reciprocates in the main scanning direction X along the guide rod 8. The main scanning direction X may be referred to simply as a scanning direction.

As described above, the liquid discharge apparatus 1 is a serial type apparatus, but a liquid discharge apparatus may be a line type apparatus in which the liquid discharger (e.g., one or more liquid discharge heads) is arranged in a head arrangement direction, which corresponds to the scanning direction of the serial type apparatus, orthogonal to a conveyance direction of a medium.

A recording medium M corresponds to an elongated printing target that is not limited in size, material, or thickness, such as a paper medium or vinyl chloride medium. The recording medium may be referred to simply as a medium. The liquid discharge apparatus 1 includes a feeding roller 41 including a feeding motor and a reeling roller 61 including a reeling motor. The feeding roller 41 is disposed on the rear side of the liquid discharge apparatus 1 in a sub-scanning direction Y. The reeling roller 61 is disposed on the front side of the liquid discharge apparatus 1 in the sub-scanning direction Y.

The recording medium M wound around the feeding roller 41 is pulled out and then is set on a platen of the support 7. A predetermined image is printed onto the recording medium M on the platen, and then the recording medium M is reeled around the reeling roller 61. In other words, by the driving force of the sub-scanning motor 5, the recording medium M is pulled out from the feeding roller 41, intermittently conveyed, and reeled around the reeling roller 61.

When the recording medium M is conveyed to a predetermined position by the driving of the sub-scanning motor 5, the conveyance of the recording medium M is temporarily stopped. Then, during the stop, the liquid discharge heads 31 discharge ink onto the recording medium M while the carriage 3 reciprocates in the main scanning direction X along the guide rod 8 by the driving of the main-scanning motor 4. Thus, an image, such as characters, a figure, a picture, or a photograph, is formed on the recording medium M.

As described above, the liquid discharge apparatus 1 serves as an inkjet printer including inkjet liquid discharge heads. The liquid discharge apparatus 1 corresponds to, for example, a serial type printer that performs printing while moving the carriage 3. The liquid discharge apparatus 1 may serve as a wide format printer, in which the carriage 3 has a long movement distance in the main scanning direction X.

As illustrated in FIG. 2, the liquid discharge apparatus 1 includes a conveyance mechanism including a feeding unit 40, a conveyance unit 50, and a reeling unit 60. The feeding unit 40 is disposed at the rear of the liquid discharge apparatus 1. The reeling unit 60 is disposed at the front of the liquid discharge apparatus 1. The conveyance unit 50 is disposed upstream from a liquid discharge position C opposed to the carriage 3 in a conveyance direction B of the recording medium M.

The conveyance direction B of the recording medium M corresponds to a direction along the surface of the recording medium M that ranges from the position at which the recording medium M is pulled out from the feeding roller 41 to the position at which the recording medium M is reeled around the reeling roller 61. In the following description, the conveyance direction B of the recording medium M may be referred to simply as a conveyance direction, and the upstream side and the downstream side in the conveyance direction may be referred to simply as the upstream side and the downstream side, respectively. A face, onto which liquid is to be discharged, of the recording medium M (upper face in FIG. 2) is referred to as a discharge face (i.e., a first face), and a face opposite the discharge face is referred to as a back face (i.e., a second face).

The support 7 includes a first platen 71, a second platen 72, and a third platen 73. These platens extend in the main scanning direction orthogonal to the surface of the paper on which FIG. 2 is drawn to support the recording medium M from the back face in the main scanning direction. The first platen 71 is disposed on the upstream side of the liquid discharge position C in the conveyance direction B of the recording medium M. The second platen 72 is opposed to the liquid discharge position C to support the recording medium M at the time of liquid discharge. The third platen 73 is opposed to a curing heater 23 on the downstream side of the liquid discharge position C. These platens are, for example, plate-shaped components and are coupled to each other in the conveyance direction.

The first platen 71 has an arc-shaped cross section having one end directed downward and toward the feeding unit 40. The second platen 72 extends in the sub-scanning direction. The third platen 73 has an arc-shaped cross section having one end directed downward and toward the reeling unit 60. The second platen 72 has small suction holes 72a at least in a printing area directly below the carriage 3 so that the recording medium M is attracted to the support 7 by a fan. Thus, the recording medium M does not float from the support 7, so that the recording medium M can be conveyed along the support 7.

The liquid discharge apparatus 1 includes, as heaters, a preheater 21, a platen heater 22, and the curing heater 23. These heaters each heat the recording medium M or the ink on the recording medium M (to be described in detail). These heaters are independently controllable to perform a heating operation. In other words, the curing heater 23 is separated from the preheater 21 and the platen heater 22.

The feeding unit 40 includes the feeding roller 41, a feeding motor 43, encoder sheets 44r and 44m, encoder sensors 45r and 45m, and a torque limiter 46. The recording medium M is wound around the feeding roller 41. The feeding motor 43 serves as a driving source that generates tension for the recording medium M on the feeding unit 40 side. The tension applied to the recording medium M is adjusted by the torque limiter 46.

The encoder sheet 44r is attached to a rotation shaft of the feeding roller 41 to detect an amount of rotation (rotation amount) of the feeding roller 41. The encoder sensor 45r detects the remainder of the recording medium M based on the rotation amount of the feeding roller 41 detected by the encoder sheet 44r.

The encoder sheet 44m is attached to the rotation shaft of the feeding motor 43 to detect a rotation amount of the feeding motor 43. The encoder sensor 45m detects the rotation speed of the feeding motor 43 based on the rotation amount of the feeding motor 43 detected by the encoder sheet 44m.

The feeding motor 43 rotates to apply force in the direction opposite to the sub-scanning direction Y, which is the conveyance direction of the recording medium M. Accordingly, tension is applied to the recording medium M held by a conveyance roller 51 and a pressure roller 52 of the conveyance unit 50, so that the torque limiter 46 of the feeding unit 40 starts slipping.

Thus, feeding tension for feeding the recording medium M is formed by the torque limiter 46 and is applied to the recording medium M. As a result, the recording medium M is fed onto the support 7 along with the rotation of the feeding roller 41. Thus, the tension between the feeding unit 40 and the conveyance unit 50 is kept constant.

The conveyance unit 50 includes the conveyance roller 51 as a conveyor, the pressure roller 52, the sub-scanning motor 5, an encoder sheet 54r, and an encoder sensor 55r. The sub-scanning motor 5 as a conveyance motor serves as a driving source that rotates the conveyance roller 51. The pressure roller 52 is pressed against the conveyance roller 51 so as to apply pressure to the conveyance roller 51 to transfer the power of the conveyance roller 51 to the recording medium M. Thus, the conveyance roller 51 conveys the recording medium M to the carriage 3 (including the liquid discharge heads 31) in the conveyance direction. As illustrated in FIGS. 2 and 3, the conveyance roller 51 (i.e., the conveyor) faces the back face of the recording medium M. The conveyance unit 50 including the conveyance roller 51 and the support 7 including the first platen 71, the second platen 72, and the third platen 73 may be collectively referred to as the conveyor.

The encoder sheet 54r is attached to the rotation shaft of the conveyance roller 51 to detect a rotation amount of the conveyance roller 51. The encoder sensor 55r detects the rotation speed of the conveyance roller 51 based on the rotation amount of the conveyance roller 51 detected by the encoder sheet 54r.

As the sub-scanning motor 5 rotates with the recording medium M nipped between the conveyance roller 51 and the pressure roller 52, the conveyance roller 51 rotates to convey the recording medium M in the sub-scanning direction Y.

The feeding unit 40 and the conveyance unit 50 are intermittently driven. Thus, while the carriage 3 reciprocates in the main scanning direction X by the main-scanning motor 4 described above, the recording medium M intermittently moves on the support 7.

The reeling unit 60 includes the reeling roller 61, a reeling motor 63, encoder sheets 64r and 64m, encoder sensors 65r and 65m, and a torque limiter 66. The recording medium M collected after printing is wound around the reeling roller 61. The reeling motor 63 serves as a driving source that generates tension for the recording medium M on the reeling unit 60 side. The tension applied to the recording medium M is adjusted by the torque limiter 66.

The encoder sheet 64r is attached to the rotation shaft of the reeling roller 61 to detect a rotation amount of the reeling roller 61. The encoder sensor 65r detects an amount of reeling of the recording medium M based on the rotation amount of the reeling roller 61 detected by the encoder sheet 64r.

The encoder sheet 64m is attached to the rotation shaft of the reeling motor 63 to detect a rotation amount of the reeling motor 63. The encoder sensor 65m detects the rotation speed of the reeling motor 63 based on the rotation amount of the reeling motor 63 detected by the encoder sheet 64m.

As the reeling motor 63 rotates, the torque limiter 66 starts slipping. Thus, reeling tension for reeling the recording medium M is formed and applied to the recording medium M. Accordingly, the recording medium M is reeled around the reeling roller 61 along with the rotation of the reeling roller 61.

As described above, because of the conveyance mechanism including the feeding unit 40, the conveyance unit 50, and the reeling unit 60, the liquid discharge apparatus 1 serves as a conveyance apparatus that conveys the recording medium M.

A configuration of the heaters included in the liquid discharge apparatus 1 is described below with reference to FIG. 3. As illustrated in FIG. 3, the liquid discharge apparatus 1 includes the preheater 21 as a first upstream heater, the platen heater 22 as a second upstream heater, the curing heater 23 as a downstream heater, and a cooler 24. The first upstream heater and the second upstream heater may be collectively referred to as an upstream heater. The upstream heater, such as the preheater 21 and the platen heater 22, is disposed upstream from the downstream heater, such as the curing heater 23, in the conveyance direction. FIG. 3 is different from FIG. 2 in terms of the arrangement of the feeding roller 41 and the preheater 21. The recording medium M is conveyed in the left-right direction of FIG. 3, which corresponds to the sub-scanning direction, from the feeding roller 41 to the liquid discharge position C. The arrangement of the heaters and the rollers is not limited to the arrangement in FIG. 2 or the arrangement in FIG. 3, and the liquid discharge apparatus can employ an appropriate configuration.

The preheater 21 is opposed to the back face of the recording medium M via the first platen 71 on the upstream side of the liquid discharge position C (i.e., a first position) in the conveyance direction B of the recording medium M. In other words, the preheater 21 is disposed upstream from the liquid discharge heads 31 in the conveyance direction B to heat the back face of the recording medium M at an upstream position upstream (i.e., a second position) from the liquid discharge position C in the conveyance direction B. Such a step is referred to as an upstream heating step, in particular, a first upstream heating step. This step preheats the recording medium M before liquid discharge. The liquid discharge position C corresponds to a position opposed to the carriage 3 in the conveyance direction B of the recording medium M.

The platen heater 22 is opposed to the back face of the recording medium M via the second platen 72 at the liquid discharge position C in the conveyance direction B of the recording medium M. In other words, the platen heater 22 is opposed to the liquid discharge heads 31 in the conveyance direction B to heat the back face of the recording medium M at the liquid discharge position C. Thus, dots formed with ink discharged on the recording medium M are prevented from spreading, so that a desired image can be formed on the recording medium M. Such a step is referred to as an upstream heating step, in particular, a second upstream heating step. A step of discharging ink onto the recording medium M at the liquid discharge position C is referred to as a liquid discharge step. The first platen 71 is disposed between the recording medium M and the preheater 21, and the second platen 72 is disposed between the recording medium M and the platen heater 22, to support the recording medium M. As described above, the term “heating the recording medium” in the present embodiment includes heating the recording medium indirectly via another component between the heater and the recording medium.

The curing heater 23 is disposed on the downstream side of the liquid discharge position C in the conveyance direction B of the recording medium M, facing the discharge face of the recording medium M. In other words, the curing heater 23 is disposed downstream from the liquid discharge heads 31 in the conveyance direction B to heat the discharge face of the recording medium M at a downstream position downstream from the liquid discharge position C in the conveyance direction B. In the present embodiment, the curing heater 23 is an infrared heater.

The cooler 24 is opposed to the back face of the recording medium M via the third platen 73 at the position at which the curing heater 23 heats the recording medium M in the conveyance direction B of the recording medium M. The cooler 24 includes a coolant and circulates the coolant at a temperature lower than the temperature of the recording medium M, at a position opposed to the third platen 73 in FIG. 3. Such a configuration serves as a cooling system that transfers heat from the recording medium M to the coolant via the third platen 73 to cool the recording medium M.

While the curing heater 23 heats the discharge face of the recording medium M, the cooler 24 cools a portion of the recording medium M heated by the curing heater 23 from the back face opposite the discharge face. In other words, the cooler 24 cools at least a portion of the back face of the recording medium M disposed between the curing heater 23 and the cooler 24. Such a step is referred to as a downstream heating and cooling step. The portion of the recording medium M heated by the curing heater 23 is, for example, a heated portion (range) D illustrated in FIG. 3. The heated portion D of the recording medium M by the curing heater 23 corresponds to the range from the most upstream position to the most downstream position of the heating portion of the curing heater 23 in the conveyance direction of the recording medium M. A line segment extending from an upstream end of the heated portion D in the direction orthogonal to the conveyance direction of the recording medium M intersects the heating portion of the curing heater 23 at the most upstream position, and a line segment extending from a downstream end of the heated portion D in the direction orthogonal to the conveyance direction of the recording medium M intersects the heating portion of the curing heater 23 at the most downstream position on the surface of the paper on which FIG. 3 is drawn. The surface of the paper on which FIG. 3 is drawn is orthogonal to a width direction of the recording medium M. The conveyance direction of the recording medium M corresponds to the tangential direction of the recording medium M at a curved portion of the recording medium M as illustrated in FIG. 3. The heated portion D is not limited thereto, and thus the heated portion (range) D by the downstream heater (e.g., the curing heater 23) may be defined by actual measurement. The width direction of the recording medium M is a direction orthogonal to the conveyance direction of the recording medium M on the surface of the recording medium M. In the present embodiment, the cooler 24 is opposed to the recording medium M in a range wider than the heated portion D. The range includes the entire range of the heated portion D of the recording medium M. In other words, the downstream heater heats a first region of the first face of the medium, the cooler cools a second region of the second face of the medium, and the second region is larger than the first region and overlaps the first region. However, an embodiment of the present disclosure is not limited thereto, and thus the range in which the cooler 24 is opposed to the recording medium M may be the entire heated portion D or may be part of the heated portion D.

In the present embodiment, the curing heater 23 heats the recording medium M, on which an image has been formed with ink discharged from the liquid discharge heads 31, at high temperature on the downstream side of the liquid discharge heads 31 in the conveyance direction of the recording medium M. Thus, the ink on the recording medium M is rapidly dried and cured to prevent the ink from being blurred on the recording medium M, so that a sharp image can be printed.

On the other hand, due to heating by the curing heater 23, the recording medium M may expand or warp. When a substance is heated, absorbed thermal energy increases atomic or molecular kinetic energy, leading to thermal expansion of the substance. Accordingly, for example, when the curing heater 23 heats the recording medium M, the recording medium M may evenly extend in the conveyance direction or unevenly extend in the conveyance direction. As a result, the recording medium M may corrugate due to the uneven extensions at places in the conveyance direction. Thus, the appearance of the recording medium M after printing may deteriorate, or the accuracy of the dimensions of the formed image may deteriorate, affecting the quality of the recording medium M after printing.

To prevent such deformation of the recording medium M, the curing heater 23 heats the discharge face and the cooler 24 cools the back face at the same time. In other words, the portion of the recording medium M heated by the curing heater 23 is cooled from the back face. Thus, the ink on the recording medium M is rapidly dried and cured. In addition, the cooler 24 cools the recording medium M from the back face to prevent the temperature of the recording medium M from increasing. Accordingly, the recording medium M is prevented from thermally expanding. Typically, the recording medium M is formed of a material relatively low in thermal conductivity, and thus thermal energy is likely to gradually transfer in the recording medium M. As described above, one face of the recording medium M is heated, and the other face of the recording medium M is cooled. Accordingly, the cooler 24 cools the recording medium M while the curing heater 23 minimizes thermal influence on drying and curing of the ink in the heated portion D to achieve the above-described effects. Thus, the recording medium M is prevented from thermally expanding so as to prevent the recording medium M after image formation from warping or corrugating. Thus, the dimensions of the recording medium M after printing can be stabilized. In particular, for printing a high-resolution image, the above-described configuration is suited to rapidly drying and curing the ink so as to prevent the ink from being blurred.

According to such thermal expansion of the recording medium M due to heating as above, a longer recording medium M accumulates more heat. In particular, such a continuous recording medium M as in the present embodiment is more likely to deform. Accordingly, simultaneous heating and cooling with the above-described configuration is preferable.

An infrared heater as the downstream heater efficiently heats the ink on the recording medium M. In other words, heat can be rapidly supplied to the ink by short-wavelength infrared radiation, so that thermal energy can be directly transferred to the ink.

A heat exchange system with a coolant as the cooler uniformly cools the back face of the recording medium M, so that the recording medium M can be effectively prevented from deforming. In this case, the temperature of the recording medium M can be easily adjusted by the cooler in accordance with the thickness or material of the recording medium M or printing conditions so as to adjust the level of the effect of cooling, so that the temperature of the recording medium M can be finely adjusted.

As described above, the back face of the recording medium M is heated before printing or during printing by the upstream heater such as the preheater 21 or the platen heater 22 and additionally cooled after printing by the cooler 24. Thus, the effect of preventing dots from spreading at the time of liquid discharge and the effect of preventing the recording medium M from deforming can be both achieved.

The heating temperature of the recording medium M by the downstream heater such as the curing heater 23 is set higher than the heating temperature of the recording medium M by the upstream heater such as the preheater 21 or the platen heater 22. Such a configuration rapidly dries the ink on the recording medium M, but may cause the recording medium M to deform. Accordingly, the configuration of simultaneous drying and cooling described above is preferable.

As described above, the curing heater 23 and the cooler 24 are disposed just downstream of the liquid discharge position C in the conveyance direction of the recording medium M. For example, an additional step such as heating is not performed and a conveyor such as a conveyance roller is not installed between the liquid discharge position C, and the curing heater 23 or the cooler 24 in the conveyance direction of the recording medium M. Such a configuration heats and cures the ink on the recording medium M immediately after an image forming operation to the recording medium M, so that the ink can be effectively prevented from being blurred. On the other hand, it is short to dissipate heat from the recording medium M, and thus the heat at the time of liquid discharge is likely to remain in the recording medium M. Accordingly, the configuration of simultaneous drying and cooling described above is preferable.

As described above, the recording medium M is conveyed along a bent path. In other words, the recording medium M is curved while being conveyed as viewed in the main scanning direction as illustrated in FIG. 3. The curing heater 23 is disposed on the outer circumferential side of the curved portion of the recording medium M. The cooler 24 is disposed on the inner circumferential side of the curved portion of the recording medium M. With such a configuration, the distance between the curing heater 23 and the recording medium M is likely to vary depending on the position of the recording medium M. The range of the recording medium M close to the curing heater 23 can be limited to a desired local range, and thus the curing heater 23 locally heats the range of the recording medium M.

Accordingly, the heating portion and the other portion of the recording medium M can be easily distinguished. For example, the curing heater 23 can effectively heat the image forming area of the recording medium M. On the other hand, the recording medium M is likely to thermally expand circumferentially outward. Accordingly, the configuration described above is preferable to prevent the recording medium M from expanding.

A blower can be used as the downstream heater to blow air at a temperature higher than the temperature of the recording medium M onto liquid such as the ink on the recording medium M. A blower can be used as the cooler to blow air at a temperature lower than the heating temperature of the downstream heater onto the back face of the recording medium M. As a heater or cooler, instead of the above-described configuration, a known appropriate configuration can be employed.

The above-described embodiments are illustrative and do not limit the present disclosure. Numerous additional modifications and variations are possible in light of the above teachings. It is therefore to be understood that within the scope of the appended claims.

In the present disclosure, the liquid to be discharged is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. More specifically, examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The term “liquid” includes not only ink but also paint, a pretreatment liquid, a binder, and an overcoat liquid.

In the present disclosure, the term “liquid discharge apparatus” drives the liquid discharge head to discharge liquid. The term “liquid discharge apparatus” used herein includes, in addition to apparatuses to discharge liquid to a recording medium serving as a medium onto which liquid can adhere, apparatuses to discharge liquid into gas (air) or different liquid. In the above-described embodiments, the liquid discharge apparatus discharges liquid while the carriage moves the liquid discharge head in the main scanning direction (i.e., a serial head type). Alternatively, the liquid discharge apparatus may be a line head type.

For example, the “liquid discharge apparatus” may further include devices relating to feeding, conveying, and ejecting of the medium onto which liquid can adhere and also include a pretreatment device and an aftertreatment device.

The “liquid discharge apparatus” may be, for example, an image forming apparatus to form an image on a sheet by discharging ink, or a three-dimensional fabrication apparatus to discharge fabrication liquid to a powder layer in which powder material is formed in layers to form a three-dimensional object.

The “liquid discharge apparatus” is not limited to an apparatus that discharges liquid to visualize meaningful images such as letters or figures. For example, the discharge apparatus may be an apparatus that forms patterns having no meaning or an apparatus that fabricates three-dimensional images.

The above-described term “medium onto which liquid can adhere” represents a medium on which liquid is at least temporarily adhered, a medium on which liquid is adhered and fixed, or a medium into which liquid adheres and permeates. The medium onto which liquid can adhere corresponds to the recording medium in the above embodiments. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

Examples of materials for the “medium onto which liquid can adhere” include any materials to which liquid can adhere even temporarily, such as paper, thread, fiber, fabric, leather, metal, plastic, glass, wood, and ceramic.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The terms “image formation,” “recording,” “printing,” “image printing,” and “fabricating” used herein may be used synonymously with each other.

Aspects of the present disclosure are, for example, as follows.

### Aspect 1

According to Aspect 1, a liquid discharge apparatus includes a liquid discharger, an upstream heater, a downstream heater, and a cooler. The liquid discharger discharges a liquid onto a recording medium. The upstream heater heats the recording medium at a liquid discharge position of the liquid discharger onto the recording medium or on an upstream side of the liquid discharge position in a recording-medium conveyance direction. The downstream heater is controllable independently of the upstream heater. The downstream heater heats a face of the recording medium, onto which the liquid is discharged, on a downstream side of the liquid discharge position in the recording-medium conveyance direction. The cooler cools, from an opposite side opposite the face, a portion of the recording medium heated by the downstream heater.

In other words, a liquid discharge apparatus includes a liquid discharger, a conveyor, a downstream heater, an upstream heater, and a cooler. The liquid discharger discharges a liquid, onto a first face of a medium, in a discharge direction and is movable or arranged in a scanning direction orthogonal to the discharge direction. The conveyor faces a second face of the medium opposite to the first face and conveys the medium to the liquid discharger in a conveyance direction orthogonal to the scanning direction. The downstream heater is disposed downstream from the liquid discharger in the conveyance direction. The downstream heater heats the first face of the medium. The upstream heater is disposed upstream from the downstream heater and separated from the downstream heater in the conveyance direction, to heat the second face of the medium. The cooler cools at least a portion of the second face of the medium disposed between the downstream heater and the cooler.

### Aspect 2

According to Aspect 2, in the liquid discharge apparatus of Aspect 1, the upstream heater heats another face of the recording medium opposite the face onto which the liquid is discharged.

In other words, the upstream heater incudes a first upstream heater at a first position opposed to the liquid discharger to heat the second face of the medium at the first position and a second upstream heater at a second position upstream from the first position in the conveyance direction to heat the second face of the medium at the second position.

### Aspect 3

According to Aspect 3, in the liquid discharge apparatus of Aspect 1 or 2, a heating temperature of the downstream heater is higher than a heating temperature of the upstream heater.

In other words, the upstream heater heats the medium to a first heating temperature, and the downstream heater heats the medium to a second heating temperature higher than the first heating temperature.

### Aspect 4

According to Aspect 4, in the liquid discharge apparatus of any one of Aspects 1 to 3, the upstream heater includes: a first upstream heater to heat the upstream side of the liquid discharge position in the recording-medium conveyance direction; and a second upstream heater to heat the liquid discharge position in the recording-medium conveyance direction.

In other words, the downstream heater heats a first region of the first face of the medium. The cooler cools a second region of the second face of the medium. The second region is larger than the first region and overlaps the first region.

### Aspect 5

According to Aspect 5, in the liquid discharge apparatus of any one of Aspect 1 to 4, the downstream heater includes an infrared heater.

### Aspect 6

According to Aspect 6, in the liquid discharge apparatus of any one of Aspects 1 to 4, the downstream heater includes a blower to blow air onto the recording medium. The air is higher in temperature than the recording medium.

In other words, the downstream heater includes a blower to blow air at an air temperature higher than a temperature of the medium onto the medium.

### Aspect 7

According to Aspect 7, in the liquid discharge apparatus of any one of Aspects 1 to 6, the cooler includes a coolant and cools the recording medium by heat transfer from the recording medium to the coolant.

In other words, the cooler includes a coolant to cool the medium by heat transfer from the medium to the coolant.

### Aspect 8

According to Aspect 8, in the liquid discharge apparatus of any one of Aspects 1 to 6, the cooler includes a blower to blow air onto the recording medium. The air is at a temperature lower than a heating temperature of the downstream heater.

In other words, the downstream heater heats the medium to a heating temperature. The cooler includes a blower to blow air at an air temperature lower than the heating temperature onto the medium.

### Aspect 9

According to Aspect 9, a liquid discharge method includes: heating a recording medium by an upstream heater at a liquid discharge position at which a liquid is discharged onto the recording medium or on an upstream side of the liquid discharge position in a recording-medium conveyance direction; discharging the liquid onto the recording medium by a liquid discharger at the liquid discharge position; heating a face of the recording medium, onto which the liquid is discharged, by a downstream heater controllable independently of the upstream heater, on a downstream side of the liquid discharge position in the recording-medium conveyance direction; and cooling, from an opposite side opposite the face, a portion of the recording medium heated by the downstream heater.

In other words, a liquid discharge method includes discharging a liquid, onto a first face of a medium, in a discharge direction at a liquid discharge position, conveying the medium to the liquid discharge position in a conveyance direction orthogonal to the discharge direction, heating the first face of the medium at a downstream position downstream from the liquid discharge position in the conveyance direction, heating a second face of the medium opposite the first face at an upstream position upstream from the downstream position in the conveyance direction, and cooling at least a portion of the second face of the medium at the downstream position in the conveyance direction.

### Aspect 10

According to Aspect 10, in the liquid discharge method of Aspect 9, the upstream heater heats another face of the recording medium opposite the face onto which the liquid is discharged.

### Aspect 11

According to Aspect 11, in the liquid discharge method of Aspect 9 or 10, a heating temperature of the downstream heater is higher than a heating temperature of the upstream heater.

### Aspect 12

According to Aspect 12, in the liquid discharge method of any one of Aspects 9 to 11, the heating the recording medium by the upstream heater includes: heating the upstream side of the liquid discharge position in the recording-medium conveyance direction by a first upstream heater; and heating the liquid discharge position in the recording-medium conveyance direction by a second upstream heater.

### Aspect 13

According to Aspect 13, in the liquid discharge method of any one of Aspects 9 to 12, the downstream heater includes an infrared heater.

### Aspect 14

According to Aspect 14, in the liquid discharge method of any one of Aspects 9 to 12, the downstream heater includes a blower to blow air onto the recording medium. The air is higher in temperature than the recording medium.

### Aspect 15

According to Aspect 15, in the liquid discharge method of any one of Aspects 9 to 14, the cooler includes a coolant and cools the recording medium by heat transfer from the recording medium to the coolant.

### Aspect 16

According to Aspect 16, in the liquid discharge method of any one of Aspects 9 to 14, the cooler includes a blower to blow air onto the recording medium. The air is at a temperature lower than a heating temperature of the downstream heater.

According to one aspect of the present disclosure, a recording medium can be prevented from deforming due to heating.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge apparatus comprising:
a liquid discharger to:
discharge a liquid, onto a first face of a medium, in a discharge direction; and
movable or arranged in a scanning direction orthogonal to the discharge direction;
a conveyor to:
face a second face of the medium opposite to the first face; and
convey the medium to the liquid discharger in a conveyance direction orthogonal to the scanning direction;
a downstream heater downstream from the liquid discharger in the conveyance direction,
the downstream heater to heat the first face of the medium;
an upstream heater:
upstream from the downstream heater; and
separated from the downstream heater in the conveyance direction,
to heat the second face of the medium;
a cooler to cool at least a portion of the second face of the medium disposed between the downstream heater and the cooler.

2. The liquid discharge apparatus according to claim 1,
wherein the upstream heater incudes:
a first upstream heater at a first position opposed to the liquid discharger to heat the second face of the medium at the first position; and
a second upstream heater at a second position upstream from the first position in the conveyance direction to heat the second face of the medium at the second position.

3. The liquid discharge apparatus according to claim 1,
wherein the upstream heater heats the medium to a first heating temperature, and
the downstream heater heats the medium to a second heating temperature higher than the first heating temperature.

4. The liquid discharge apparatus according to claim 1,
wherein the downstream heater heats a first region of the first face of the medium,
the cooler cools a second region of the second face of the medium,
the second region is larger than the first region and overlaps the first region.

5. The liquid discharge apparatus according to claim 1,
wherein the downstream heater includes an infrared heater.

6. The liquid discharge apparatus according to claim 1,
wherein the downstream heater includes a blower to blow air at an air temperature higher than a temperature of the medium onto the medium.

7. The liquid discharge apparatus according to claim 1,
wherein the cooler includes a coolant to cool the medium by heat transfer from the medium to the coolant.

8. The liquid discharge apparatus according to claim 1,
wherein the downstream heater heats the medium to a heating temperature, and
the cooler includes a blower to blow air at an air temperature lower than the heating temperature onto the medium.

9. A liquid discharge method comprising:
discharging a liquid, onto a first face of a medium, in a discharge direction at a liquid discharge position;
conveying the medium to the liquid discharge position in a conveyance direction orthogonal to the discharge direction;
heating the first face of the medium at a downstream position downstream from the liquid discharge position in the conveyance direction;
heating a second face of the medium opposite the first face at an upstream position upstream from the downstream position in the conveyance direction; and
cooling at least a portion of the second face of the medium at the downstream position in the conveyance direction.
